(19) United States
(12) Patent Application Publication
(10) Pub. No.: US 2006/0199022 A1
(43) Pub. Date: Sep. 7, 2006

(54) Laminates and packages produced therefrom

(75) Inventor: Robert Hugh Clare, Gloucestershire (GB)

Correspondence Address: BACON & THOMAS, PLLC, 625 SLATERS LANE, FOURTH FLOOR, ALEXANDRIA, VA, 22314, US

(73) Assignee: AMOR FLEXIBLES WINTERBOURNE Ltd., LONDON (GB)

(21) Appl. No.: 10/543,694

(22) PCT Filed: Jan. 29, 2004
(86) PCT No.: PCT/GB04/00354

§ 371 Date: Jul. 28, 2005

(30) Foreign Application Priority Data
Jan. 29, 2003 (GB) 0302014.6

(51) Int. Cl. B32B 15/08; B32B 15/14; B32B 15/085; B32B 15/088

(52) U.S. Cl. 428/457; 428/458; 442/378; 428/480

(57) ABSTRACT

Laminates of a metal foil adhered to a water permeable layer by an adhesive which is softenable on exposure to water, and packages produced therefrom. Such packages have shown good child resistance due to the strength of the laminates which results from the presence of the adhered polymeric film. Despite the use of a water permeable film and a water softenable adhesive, sucking sealed blister packages has not been found to soften the adhesive sufficiently to allow the film to be removed from the metal foil.

This invention concerns laminates and more particularly laminates of metal foils to polymeric films, for example for use as packaging materials.

Metal foils find use in packaging as lidding materials for polymeric packaging materials. One particular example of this is as a lidding material for thermoformed blister packs used to package pharmaceuticals, the metal foil generally being adhered to the thermoformed blister packs using an adhesive coating on the foil. Such packages have the advantage that individual dosage units, for example in the form of tablets, capsules or the like, are in separate compartments and can be accessed separately merely by pushing them through the metal foil by pressing an individual blister.

The ease of access to articles packaged in such packaging materials has its advantages, for example it is easier for the elderly and people with physical disabilities to gain access to the packaged articles compared, for example, with clutch operated child resistant screw caps on bottles. However, this ease of access also makes it easier for children to gain access to potentially hazardous substances within the packages.

Increasing the thickness of the metal foil, thereby increasing the force required to push articles through the foil, would make it more difficult for a child to gain access to the packaged articles. However, this would also reduce the ease of access for adults and may in some cases even make access impossible.

U.S. Pat. No. 5,339,960 describes packaging for tablets, capsules and the like consisting of a polymeric sheet having a plurality of bubble chambers sealed by a rupturable barrier which seals the tablets in the chambers. A protective over package has on one side a plurality of apertures through which the bubbles project, and on the other side a plurality of tear open tabs which when torn open allow access to the rupturable barrier. Such packaging is complicated to produce, and it also requires substantial amounts of additional packaging materials. Furthermore, it places limitations on the number of tablets which can be packaged in a single package as access to the tablets is along only one edge of the packages.

U.S. Pat. No. 5,775,505 describes another type of blister packaging consisting of a rigid container sheet having blisters formed in it, and a closure sheet which seals the individual blisters, the closure sheet consisting of a metal foil which is adhered to the container sheet by a peelable adhesive, the metal foil having a paper sheet adhered to it which strengthens the foil preventing packaged tablets being pushed through it.

Individual blisters can be torn from the container sheet using perforations in the sheet, thereby revealing a corner of the closure sheet which has not been fully adhered to the container sheet. Pulling of this non-adhered corner of the closure sheet from the container sheet results in peeling of the seal therebetween, thereby providing access to the packaged tablets.

Such packages are complicated to produce because in addition to providing tear lines between individual blisters, apertures have to be provided at their intersections to leave pull open tabs for peeling open the individual blisters. Furthermore, a complicated pattern of adhesion has to be provided to leave unadhered areas between the container sheet and the closure sheet to facilitate peeling of the latter from the individual blisters. A yet further disadvantage of these packages is that additional adhesion is proposed in order to make the packages more child resistant.

According to the present invention there is provided a laminate of a metal foil adhered to a water permeable layer by an adhesive which is softenable on exposure to water.

The present invention further provides packages comprising a laminate in accordance with the present invention adhered to a polymeric container, the water permeable layer adhered to the metal foil forming an exterior surface of the packages.

Packages in accordance with the present invention have shown good child resistance due to the strength of laminates of the present invention resulting from the presence of the adhered polymeric film, and despite the use of a water permeable film and a water softenable adhesive, sucking sealed blister packages has not been found to soften the adhesive sufficiently to allow the film to be removed from the metal foil.

However, when it is desired to open packages of the present invention, this can be effected by immersing them in water until the adhesive adhering the water permeable polymeric film to the metal foil has softened sufficiently to allow the polymeric film to be peeled from the metal foil, following which the packaged article can be pushed through the foil in conventional manner. The polymeric film adhered to the metal foil serves to increase the overall strength of the laminate, and thereby increase the force required to push packaged articles therethrough, but once the polymeric film has been removed, articles can be pressed therethrough in conventional manner using a metal foil of conventional strength.

Metal foils for use in accordance with the present invention are preferably of a type and thickness conventionally used as push through lidding films.

A wide variety of water permeable materials can be laminated to the metal foil to form laminates of the present invention. For example, they can be polymeric films, which will in general have apertures therein to permit water passing therethrough, or non-woven materials, which generally are inherently permeable to water. Polymeric films which can be used include polyesters, for example polyethylene terephthalate, and polyamides, for example nylon 6, these being generally preferred because they usually withstand temperatures used to heat seal the metal foil to polymeric materials used to form the polymeric containers. However, films made from polyethylenes or polyvinyl chloride could be used.

Other water permeable materials which can be used include non-woven materials made, for example, from nylon or a polyester, for example polyethylene terephthalate.

Although inherently water permeable polymeric films without apertures therein could in theory be used as the water permeable layer which is adhered to the metal foil, this is generally not preferred due to the generally low transmission rates of such films. Polymeric films adhered to the metal foil will, therefore, generally require apertures therein to allow water to access the adhesive layer which bonds the polymeric film to the metal foil. These apertures can be in the form of perforations or through holes, but they can have other shapes, for example slits in the film.

Non-woven materials are in general inherently permeable to water and so will not normally require any additional treatment to increase their permeability.

The adhesive used to bond the polymeric film to the metal foil should be capable of releasing the bond on exposure to liquid water which has passed through the polymeric film. Such adhesives can be water soluble or they can be such that their adhesive properties are weakened on exposure to water. Particularly preferred adhesives will be such that not only will they weaken on exposure to liquid water to allow the polymeric film to be peeled from the metal foil prior to pushing packaged articles through the foil, but their adhesive strengths will increase again once the laminates have been removed from the water and dried.

Adhesives which can be used to form laminates of the present invention include water soluble copolyesters based on terephthalic acid and a mixture of polyols, for example ethylene glycol and propylene glycol, a particularly preferred adhesive being sold under the designation MICA M-1173 (MICA-CORP).

In order to restrict the amount of film peeled from the metal foil, perforations can be provided in the film to promote tearing of the film along particular directions without removal of the film from areas of the laminate which are not to be peeled. This is of particular advantage with blister packs having a number of blisters each containing a packaged article and covered with a laminate in accordance with the present invention. The precise pattern of such perforations can be selected to facilitate the desired peeling of the film from the metal foil.

Laminates in accordance with the present invention can be used as direct replacements for metal foils as lidding materials. The metal foil rather than the polymeric film can, therefore, be adhered directly, or using an adhesive coating applied to the metal foil, to thermoformed polymeric articles, for example blister trays thermoformed from polymeric webs. The webs can be selected from a wide variety of polymeric materials, but they should be sufficiently flexible to enable packaged articles to be pushed through the metal foil by applying pressure to the web after removal of a portion of the polymeric film adhered to the metal foil.

Laminates in accordance with the present invention can be produced by known methods, for example using the water softening adhesive as a laminating adhesive to bond the polymeric film to the metal foil. Perforation of the polymeric film is preferably effected prior to the lamination process.

The base webs of packages in accordance with the present invention can be produced from polymeric materials conventionally used as base webs for adhesion to metal foils. Preferred materials for forming such base webs include polyvinyl chloride monowebs, polyvinyl chloride coated with aqueous dispersions of polyvinylidene chloride and polyvinyl chloride laminated to polychlorotrifluoroethylene (Aclar™). When the polyvinyl chloride is coated or laminated to other polymeric materials the polyvinyl chloride will in general be adhered to a metal foil containing laminate in accordance with the present invention.

Laminates and packages in accordance with the present invention will now be described with reference to the accompanying drawings in which:—

FIG. 1 is a cross section through a laminate in accordance with the present invention;

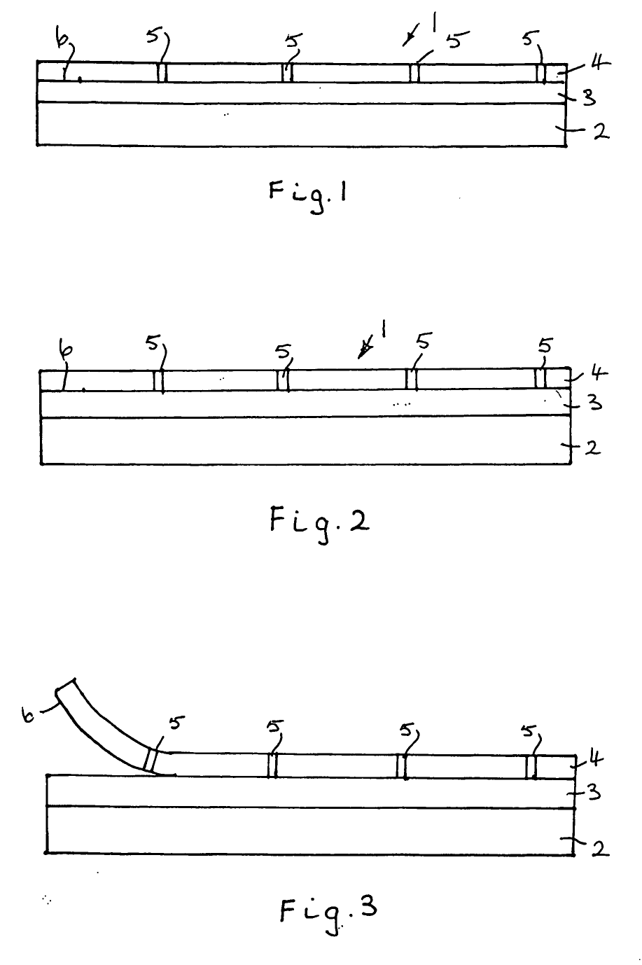

FIG. 2 corresponds to FIG. 1 after immersion of the laminate in water;

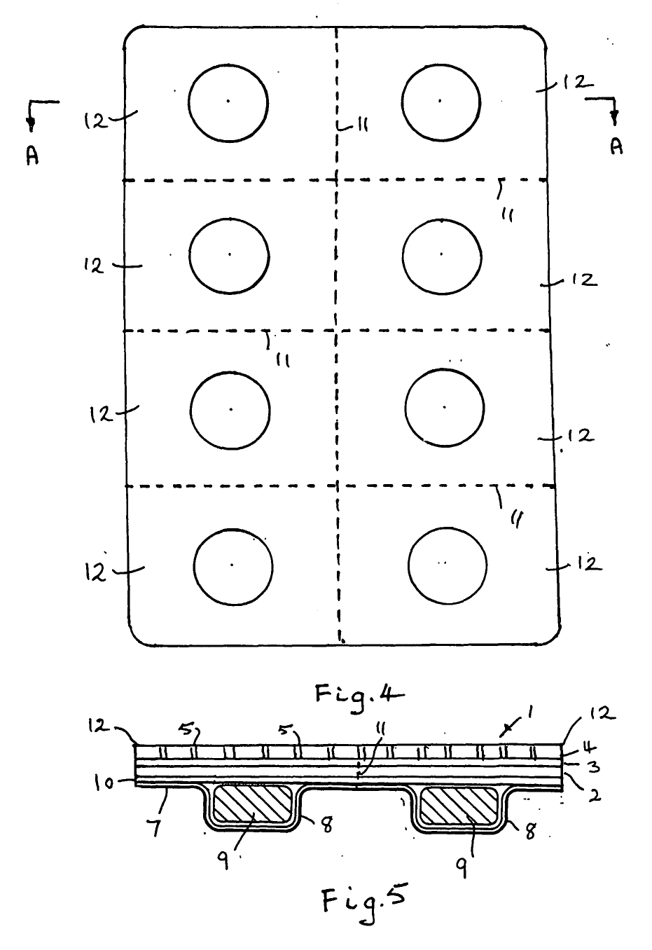

FIG. 3 shows the laminate of FIG. 2 after partial peeling;

FIG. 4 is a plan view of a package of the present invention; and

FIG. 5 is a section on line A-A of FIG. 4.

Referring to FIG. 1, a laminate in accordance with the present invention is shown at 1, and it consists of a metal foil 2 adhered by a water soluble adhesive layer 3 to a polymeric film 4. The polymeric film 4 has a plurality of through holes 5 produced, for example, using a known flame technique.

FIG. 1 shows the laminate in a dry state with the adhesive layer 3 in a dry state.

FIG. 2, however, shows the laminate of FIG. 1 after immersion in water, water having passed through the holes 5 in the polymeric film 4 and then been absorbed by the adhesive layer 3, this being represented by a slight swelling of the layer 3.

Once the adhesive layer 3 has become softened as shown in FIG. 3, the polymeric film 4 can be readily peeled from the adhesive layer 3 as shown in FIG. 3.

Peeling can be made easier by having an edge portion 6 of the polymeric film 4 not adhered to the adhesive layer 3, but it is usually unnecessary because the adhesive layer 3 usually softens sufficiently to allow the film 4 to be peeled from the foil 2 without this.

FIGS. 4 and 5 show a package in accordance with the present invention which consists of a laminate layer 1 adhered in conventional manner by a heat seal layer 10 to a thermoformed polymeric web 7 having a plurality of blisters 8 thermoformed therein, the blisters each containing a tablet 9.

Placing the package in water results in water passing through the holes 5 in the polymeric film 4 and into the adhesive layer 3 which absorbs the water and becomes soft.

The polymeric layer 3, which serves as a protection for the foil 2, can then be peeled from the adhesive layer or from the foil, depending on the relative adhesive strength of the softened adhesive to the polymeric film or to the metal foil.

The laminate 1 is preferably perforated to form tear lines 11 for separating individual packages 12 of tablets 9. The tablets 9 can then be removed from the packages 12 by immersing the packages 12 in water until the adhesive layer 3 is softened sufficiently to enable the film 4 to be peeled from the foil 2. Once this has been done the tablets can be pushed through the foil 2 in conventional manner.

The following Examples are given by way of illustration only.

### EXAMPLE 1

A cast polyester film monoweb 12 μm thick was perforated using a flame treatment method to produce a pattern of substantially circular holes with a mean diameter of 470 μm, in a square pattern with 36 holes per cm².

This film was then laminated to aluminum foil 23 μm thick using a water weakening adhesive layer 2 μm thick using an aqueous dispersion of an adhesive (MICA M-1173).

The opposite surface of the aluminum foil was then coated with a dispersion of an ethylene methacrylate/ethylene vinyl acetate blend to act subsequently as an adhesive to a polyvinyl chloride web.

Puncture tests on this laminate according to ASTM method D-3763 required a puncturing force of about 16N compared with about 8N for the same 23 μm thick aluminum foil coated with the same thickness of the ethylene methacrylate/ethylene vinyl acetate blend.

### EXAMPLE 2

A cast monoweb of polyvinyl chloride 250 μm thick was thermoformed in known manner to produce a base web for a blister pack for packaging individual dosage units of a pharmaceutical, and individual dosage units were inserted into the respective blisters. Each blister was circular with a diameter of 15 mm and a depth of 4 mm. The packaged tablets were cylindrical with a diameter of 12 mm and a height of 2.5 mm.

The laminate produced in Example 1 was then adhered to the thermoformed polyvinyl chloride monoweb by heat sealing using the outer layer of the ethylene methacrylate/ethylene vinyl acetate blend to effect the adhesion.

Attempts using reasonable force to push the dosage units through the foil/film laminate from the side of the thermoformed web failed, as did attempts to break through the film and the foil from the other side. Attempts to peel the film from the metal foil also failed.

A puncture test using the probe of the ASTM method D-3763 to push the packaged pills out of their respective blisters by applying pressure to the polyvinyl chloride blister required a force of about 25N.

The packages were then immersed in water at 23° C. and left to stand for 2 mins. The film then peeled readily from the foil and the dosage units could then be pushed through the foil in conventional manner.

A puncture test using the probe of the ASTM method D-3763 to push the packaged pills out of their respective blisters by applying pressure to the polyvinyl chloride blister after removal of the protective polyester layer required a force of about 12N.

After removing the package from the water and allowing it to dry, attempts to peel the film from areas of the laminate which had been immersed once again failed.

These packs therefore exhibited properties which can be considered to make them “child resistant” whilst at the same time enabling adults with physical difficulties to open them substantially as easily as conventional blister packs with metal foil seals.

### EXAMPLE 3

The laminate of Example 1 was heat sealed to the cast monoweb of Example 2 which had not been previously thermoformed. The resulting laminate was then cut into a number of test samples 100×50 mm.

Each sample, with the same laminate orientation, was then dipped into water at different temperatures and for different periods of time, and the results are shown in Table 1.

TABLE 1

| | | | Liquid | |
|---|---|---|---|---|
| Sample | Soak Time | Liquid | Temp | |
| No. | (mins) | Type | (° C.) | Comments on peelability |
| 1 | 0 | none | N/A | Film tears after peel |
| | | | | length ˜5 mm |
| 2 | 1 | water | 23 | Film tears after peel |
| | | | | length ˜10 mm |
| 3 | 1.5 | water | 23 | Film tears after peel |
| | | | | length ˜10 mm |
| | | | | Edges to access to |
| | | | | start peel |
| 4 | 2 | water | 23 | Film tears after peel |
| | | | | length ˜50 mm |
| 5 | 1 | water | 40 | Peeling dominant - film |
| | | | | tears occasionally |
| 6 | 1.5 | water | 40 | Peeling dominant - film |
| | | | | tears very occasionally |
| 7 | 2 | water | 40 | Peeling 100% complete |
| 8 | 2 | saliva | 23 | Film tears after peel |
| | | | | length ˜10 mm |

Repeating these tests two months later on test samples produced at the same time led to substantially similar peel results.

1. A laminate of a metal foil adhered to a water permeable layer by an adhesive which is softenable on exposure to water.

2. A laminate according to claim 1, wherein the water permeable layer comprises a polymeric film or a non-woven material.

3. A laminate according to claim 2, wherein the polymeric film comprises a polyester or a polyamide.

4. A laminate according to claim 3, wherein the water permeability of the polymeric film is substantially imparted by holes or slits therein.

5. A laminate according to claim 1, wherein the adhesive comprises a copolyester of terephthalic acid with a mixture of polyols.

6. (canceled)

7. A package comprising a laminate according to claim 1 adhered to a polymeric container, the water permeable layer adhered to the metal foil forming an exterior surface of the package.
